(19) United States
(12) Patent Application Publication
(10) Pub. No.: US 2025/0171693 A1
(43) Pub. Date: May 29, 2025

(54) REACTOR SYSTEM AND METHOD FOR PYROLYSIS OF CARBONACEOUS WASTE IN A FLUIDIZED BED OF PARTICULATE MATERIAL SUSCEPTIBLE TO INDUCTIVE HEATING

(71) Applicant: Deeptech Recycling Limited, London (GB)

(72) Inventors: Marvine BESONG, London (GB); Niels FABRICIUS, London (GB); Adrian Edward GRIFFITHS, London (GB); Diego Alejandro Sanchez MONSALVE, London (GB); Jake A S PAYNE, London (GB); Michael Steven WATSON, London (GB); Adam Christopher WELLINGS, London (GB); Christopher WINDOWS-YULE, London (GB)

(73) Assignee: Deeptech Recycling Limited, London, EN (GB)

(21) Appl. No.: 18/840,107

(22) PCT Filed: Feb. 22, 2023
(86) PCT No.: PCT/GB2023/050397

§ 371 Date: Aug. 21, 2024

(30) Foreign Application Priority Data
Feb. 23, 2022 (GB) 2202444.2

(51) Int. Cl. C10B 49/22; C10B 19/00; C10B 53/07

(52) U.S. Cl. CPC C10B 49/22; C10B 19/00; C10B 53/07

(57) ABSTRACT

A reactor system for pyrolysis of carbonaceous waste, a method of treating waste comprising carbonaceous waste by pyrolysis in the reactor system, and uses of particulate material in the reactor system and/or method, are provided. The reactor system comprises a fluidised bed pyrolysis reactor. The fluidised bed pyrolysis reactor comprises a shell defining a heating chamber, the heating chamber having a fluidised bed zone configured to contain a fluidised bed of particulate material comprising particulate material susceptible to inductive heating. The reactor system also comprises a pyrolysis induction heater assembly comprising an induction emitter configured to inductively heat the particulate material. The shell of the reactor is made from an inductively inert material.

### FIELD OF THE INVENTION

The present invention concerns a reactor system, for example including a reactor for pyrolysis of a carbonaceous feed material, such as waste material. For example, the apparatus may be suitable for treatment of plastic waste, municipal waste, and/or biomass by pyrolysis. More particularly, but not exclusively, this invention concerns a reactor system for pyrolysis of carbonaceous waste, comprising a pyrolysis reactor configured to pyrolyse carbonaceous waste to produce a pyrolysis product, wherein the pyrolysis reactor is a fluidised bed reactor configured to contain a fluidised bed of particulate material comprising particulate material susceptible to inductive heating; particulate material susceptible to inductive heating; and an induction heater configured to inductively heat the particulate material susceptible to inductive heating to appropriate temperatures. The invention also concerns related methods and products.

### BACKGROUND OF THE INVENTION

There is an increasing awareness of the need to find economic, efficient and effective methods of extracting useful products from solid carbonaceous materials, especially waste materials. In recent years, it has become apparent that not only is there a need to reduce pollution (often resulting from ineffective waste collection and processing) but also that waste is a valuable resource. This is particularly true of plastic waste. In many countries, mixed waste material is collected and taken to processing centres or recycling centres. Some categories of waste are separated out and sent to recycling processes, either at the centre or elsewhere. Waste that is not recycled may be sent to landfill or may be burnt, typically to provide either heat or electrical energy. Other waste streams (including for example waste produced by industry and/or agriculture, such as biomass) are in some cases sent directly to landfill or to be burnt without any attempt to recover potentially valuable materials.

Pyrolysis of waste has been suggested as a solution. Examples include pyrolysis of waste plastics to create an oil, gas or wax that can be processed to create fuel, lubricants and/or new plastics. Pyrolysis processes have also been used for other carbonaceous material streams, such as biomass. Various reactor configurations have been utilised in processes for pyrolysis of carbonaceous materials, including relatively simple chamber reactors (typically consisting of an empty vessel filled with feedstock and heated to thermal decomposition); screw-feed reactors (where feedstock is conveyed through a heated vessel by an auger); and more recently, fluidised bed reactors (e.g. where feed is intimately mixed with a heated particulate material fluidised by a fluidising gas).

Various approaches have been applied for heating pyrolysis reactors. Chamber reactors are relatively straightforward to heat. PCT Publication No. WO 2018/000050 A1 discloses a process for pyrolysis of mixed plastic waste in a chamber reactor fitted with a mechanical agitator, the reactor being heated by a gas burner or induction heating elements. PCT Publication No. WO 2015/034430 A1 discloses introducing carbonaceous waste materials into a metal chamber for pyrolysis. The metal walls of the reaction chamber are heated by induction to ca. 350 to 450° C. in an inert atmosphere to pyrolyse the waste materials. Gaseous distillate from the pyrolysis process is then fed to a separate chamber for use in the formation of carbon nanotubes. Sanchez Careaga et al. (Pyrolysis shaker reactor for the production of biochar, Can. J. Chem. Eng., 2020, 98, 2417-2424) discloses a small (laboratory) scale mechanically agitated reactor for the pyrolysis of biomass. The metal reactor chamber is heated inductively by means of surrounding induction coils. Sabogal et al. (Design and thermal characterization of an induction-heated reactor for pyrolysis of solid waste, Chem. Eng. Res. & Des., 2021, 173:206-214) discloses a small-scale pyrolysis reactor, comprising a metal chamber and a ‘preheater’ with metal exchanger walls, the walls being heated inductively by means of surrounding induction coils. Latifi et al. (A novel induction heating fluidized bed reactor, J. AIChE, 2015, 61:5, 1507-1523) discloses a small-scale, semi-batch induction heated fluidized bed reactor that can operate at temperatures of up to 1500° C., with solid feedstock such as coal, biomass, waste, and petroleum coke, in reactions such as thermal and catalytic cracking, pyrolysis, gasification and combustion. Eight metal (e.g. stainless steel) rods placed inside the reaction zone act as induction heating elements. Silica particles are used as fluidised bed particulate material. A problem common to all such reactor systems is the unwanted build-up of deposits such as char on heated surfaces in the reactor, especially when treating solid materials such as plastic waste or biomass. Removal of such deposits, which can clog reactors and/or form an insulating layer which reduces the efficiency of heat transfer within the reactor, is challenging. Also, it can be difficult to provide a consistent temperature throughout the reactor zone—existing designs have a tendency to form unfavourable temperature gradients within the reactor.

PCT Publication No. WO 2014/128430 A1 (Recycling Technologies) discloses a process and apparatus for the treatment of waste comprising Mixed Plastic Waste. The process comprises feeding the waste to a pyrolysis reactor, and pyrolysing the waste in the pyrolysis reactor to produce a pyrolysis product. The pyrolysis may be carried out in a fluidised bed pyrolysis reactor. The temperature and residence time of material in the reactor is controlled in dependence on an attribute of the pyrolysis product, such as hydrocarbon chain length. Thus, WO 2014/128430 A1 allows for the use of a variable Mixed Plastic Waste feed by using feedback control based on the nature of the pyrolysis product. PCT Publication Nos. WO 2021/074626 A1 and WO 2021/089995 A1 (Recycling Technologies) disclose further processes for treating waste, such as mixed plastic waste, comprising pyrolysing the waste in a fluidised bed pyrolysis reactor to produce a pyrolysis product. Particulate material of the fluidised bed may be heated in a fluidised bed combustion reactor supplied with a fuel, thus providing a dual bed reactor system where particulate material is circulated between a fluidised bed pyrolysis reactor where it provides heat for pyrolysis and a fluidised bed combustion reactor where it is reheated. Typically, fuel for such combustion reactors is light hydrocarbon gas, which may be a by-product of the pyrolysis process. Fuel may be burnt in the combustion reactor, thereby heating the particulate by contact with hot combustion gases.

There remains a need for efficient and effective processes for pyrolysis of carbonaceous materials, in particular pyrolysis of plastic and/or biomass materials.

### SUMMARY OF THE INVENTION

In a first aspect, the present invention provides a reactor system for pyrolysis of carbonaceous waste, comprising a fluidised bed pyrolysis reactor configured to pyrolyse carbonaceous waste to produce a pyrolysis product, wherein the reactor comprises a heating chamber having a fluidised bed zone configured to contain a fluidised bed of particulate material comprising particulate material susceptible to inductive heating; and a pyrolysis induction heater assembly comprising an induction emitter configured to inductively heat said particulate material susceptible to inductive heating, for example to a temperature of from 350° C. to 800° C., in the fluidised bed zone. Optionally, the reactor comprises a shell defining the heating chamber. Preferably, the shell defining the heating chamber is inductively inert. Optionally, the shell defining the heating chamber is an inner shell, and the reactor further comprises an outer shell disposed around the inner shell.

It has been found that an induction heater assembly configured to inductively heat particulate material can provide an especially environmentally friendly, cost effective and safe means for providing pyrolysis heat. In particular, using electrical power for heating can avoid the need for combustion of a fuel (often used in known systems to provide heat for pyrolysis), and inductively heating particulate material itself allows an especially efficient heating of feedstock in the reactor. Furthermore, such a reactor system may be more compact, and/or simpler to operate, than previously known fluidised bed pyrolysis reactor systems, for example those in which particulate material is heated by contact with hot gases. Depending on the reactor configuration, it has been found that the use of induction can have several advantages, including: a) simplifying a pyrolysis system (since other apparatus for heating, such as a combustion reactor, becomes redundant); b) avoiding hazards associated with the transport of solids between an oxygen-free pyrolysis environment and oxygenated combustion environment; and c) increasing the energy efficiency of the pyrolysis system. In relation to c), the use of inductive heating as opposed to traditional combustion heating is believed to help to reduce the carbon footprint of the system, reducing system greenhouse gas emissions. For example, renewable energy sources, such as wind, hydroelectric power, solar, and geothermal energy, may be used to meet the electricity needs of an induction heater assembly. The use of electricity derived from “clean” sources such as these can help to reduce CO₂ emissions. Moreover, as the proportion of electricity generated worldwide from “clean” sources grows, electricity production costs are expected to fall, providing operational cost savings. Additionally, it has been found that such a reactor system having an induction heater assembly can achieve fast start-up times compared to known reactor systems, for example because heat can rapidly be introduced to a body of particulate material, and improved temperature control. In this connection, it has been found that an induction heater may permit easier fine-tuning of heating, for example heating to a specific temperature range, achieving uniform heating throughout a body of particulate material, and/or varying the heat in specific areas of a reactor system, for example as compared to heating particulate material by contact with hot gases. Yet further, it has been found that directly inductively heating the particulate material itself (e.g. as opposed to heating the particulate material by contact with heating elements or heated surfaces) can help to avoid build-up of unwanted deposits such as char on surfaces in the reactor (especially when treating solid materials such as plastic waste or biomass). That in turn may simplify reactor maintenance, reducing or avoiding the need to remove such deposits, which can clog reactors and/or form an insulating layer which reduces the efficiency of heat transfer within the reactor. The particulate material itself may be relatively straightforward to clean, for example by removing a portion of the particles from the pyrolysis reactor, cleaning the particles and feeding the particles back into the pyrolysis reactor.

As used herein, a pyrolysis reactor is a reactor configured to pyrolyse a feedstock, thereby producing a pyrolysis product (for example, a wax, liquid or gas hydrocarbon product, which may for example be used as a fuel or feedstock in another process). Pyrolysis may be performed in the absence of oxygen, or in the presence of only trace amounts of oxygen, for example in an atmosphere having less than 1%, 0.5%, 0.25%, 0.1%, 0.01%, or 0.001% by volume oxygen. As used herein, the term pyrolysis encompasses ‘depolymerisation’, which can result from thermal treatment of a polymer or mixture of polymers. Optionally, the pyrolysis reactor is configured for pyrolysis of a polymer feedstock, such as pyrolysis of one of more polyolefins and/or depolymerisation of a polymer feedstock, such as polystyrene. As used herein, the term feedstock refers to material fed into a pyrolysis reactor, for example a fluidised bed pyrolysis reactor, and may be or comprise one or more carbonaceous materials, such as waste materials.

Non-limiting examples of carbonaceous materials are plastics (including, for example, plastic waste, mixed plastic waste, or segregated plastic waste such as polystyrene plastic waste); biomass (including waste biomass, by-product biomass and crop biomass); carbonaceous composites such, for example, as plastic composites, which may comprise fibres, fillers, particulates, or other reinforcing elements configured to modulate the strength and/or stiffness of the plastic (including, for example, glass-reinforced plastics, i.e. GRPs, and carbon fibre-reinforced polymer composites) and their derivatives; and carbonaceous fibres and their derivatives (including, for example, polyester, nylon, rayon and acrylic fibres). Optionally, the carbonaceous material is a solid, a liquid or a mixture of a solid and a liquid, preferably a solid, at a temperature of 25° C. and a pressure of 1 bar. For example, the carbonaceous material may comprise solid material, such as biomass and/or plastic waste. The plastic waste may, for example, comprise polyolefin and/or polystyrene waste. It will be appreciated that any form of biomass material may be used, including for example food waste, forestry products (such as wood-based chippings or pellets), and crops (such as whole crops or crop by-products such as straw).

It will be understood that, in the fluidised bed zone of a fluidised bed reactor, a solid particulate substance is agitated with a pressurised fluid, suspending the particles and causing the particulate material to behave as a fluid. Feed material is introduced into the fluidised bed zone, with the feed material becoming entrained in the fluidised particulate material. Preferably, no mechanical agitator (such as a stirrer or paddle) is utilised for agitation of the particulate material of the fluidised bed, for example the fluidised bed reactor does not comprise a mechanical agitator. Additionally or alternatively, particulate material is fluidised only by agitation with the pressurised fluid. It may be that reactors free from mechanical agitators are less complex to manufacture, operate and maintain, for example having fewer moving parts vulnerable to failure and/or fewer in-reactor surfaces at risk of becoming clogged with by-products such as char.

A fluidised bed zone of a fluidised bed reactor will be understood to have a bottom, a top and sides. Fluidising medium (e.g. fluidising gas) may be introduced into the bottom of the fluidised bed zone, for example by a distributor, and the net direction of fluid flow through the fluidised bed may be vertically from the bottom to the top. Preferably, the fluidised bed reactor comprises a fluidising medium distributor, which is for introducing fluidising medium into the fluidised bed zone. The distributor may be positioned below the fluidised bed zone. The distributor may preferably comprise an array of ducts with orifices, for example in their surface, the ducts being configured such that a fluidising medium is fed to the ducts and exits the ducts through the orifices into the reactor. The ducts may for example be arranged in a row or a grid. It will be appreciated that steps may be taken to prevent particulate material falling from the fluidised bed falling into, and blocking, the orifices. The orifices may, for example, be in the underside of the ducts. In another example, the orifices may comprise a nozzle comprising a cap to prevent particles blocking the orifice.

The diameter of the fluidised bed zone (and thus the fluidised bed, when the reactor is in use) may be defined as be the distance from one side to the other, in a direction perpendicular to the net direction of fluid flow through the fluidised bed zone. The height of the fluidised bed zone (and thus the fluidised bed when the reactor is in use) may be defined as the distance from the bottom of the zone to its top, with the bottom of the zone considered to be the position of the fluidising medium distributor when present. Thus, the height is measured in a direction parallel to the net direction of flow of fluidising fluid through the fluidised bed. The space above the fluidised bed zone is known as the head space, or freeboard zone.

Optionally, the fluidised bed zone has a substantially constant diameter along its height. Optionally, the fluidised bed zone has a cylindrical shape. Relatively small height dimensions of the fluidised bed zone may allow convenient transport, for example transport of the reactor mounted in an ISO compatible intermodal container frame (although this is not essential). The fluidised bed zone of the pyrolysis reactor may have an aspect ratio (height: width) of around 1:1, for example in the range 0.5:1 to 1:2, preferably in the range 0.8:1 to 1:1.2. The fluidised bed of the pyrolysis reactor may have a mass of 0.1 to 100 tonnes, such as 0.1 to 50 tonnes, such as 0.1 to 20 tonnes, such as 1 to 10 tonnes, preferably 2 to 5 tonnes, more preferably 2.5 to 3.5 tonnes. The resulting pyrolysis reactor size and shape may allow efficient treatment of carbonaceous waste. Accordingly, the reactor system of the first aspect of the invention is preferably sized and configured to treat from 200 to 200,000 tonnes per year of carbonaceous waste, such as 200 to 100,000 tonnes per year of carbonaceous waste, such as 200 to 50,000 tonnes per year of carbonaceous waste, more preferably 5,000 to 20,000 tonnes per year of carbonaceous waste and even more preferably 6,000 to 15,000 tonnes per year of carbonaceous waste.

A suitable fluidising medium (e.g. fluidising gas) and fluidising medium distributor may be used, such as that described in International (PCT) Publication No. WO2014/128430A1, the contents of which are incorporated herein by reference. The distributor design may help achieve a uniform distribution of the fluidising medium across the bed, and thus a uniform heating of the bed.

Optionally, the reactor system of the first aspect of the invention further comprises cleaning apparatus for cleaning particulate material, wherein the pyrolysis reactor and the cleaning apparatus are configured so that, in use, spent particulate material is transferred from the pyrolysis reactor to the cleaning apparatus for cleaning, and cleaned particulate material is transferred from the cleaning apparatus to the pyrolysis reactor.

It will be understood that the fluidised bed of a fluidised bed pyrolysis reactor may accumulate contaminants over time, especially when the carbonaceous waste is mixed plastic waste, and the particulate material may need cleaning. For example, tar, char or coke may accumulate on the particles. Cleaning to avoid a build-up of char in the pyrolysis reactor could be achieved by shutting down the pyrolysis reactor and removing the particulate material, but it may advantageously be performed on-line by removal of contaminated particles from the fluidised bed and replacement with cleaned particles, for example during operation of the fluidised bed reactor. Thus, optionally, contaminated particles are withdrawn and circulated through a cleaning apparatus; then, optionally, they are returned to the fluidised bed reactor. Particulate material so withdrawn from the pyrolysis reactor may be referred to herein as spent particulate material. Particulate material returned to the pyrolysis reactor may be referred to herein as regenerated, or clean, particulate material. Thus, a portion of spent particulate material may preferably be removed from the reactor and cleaned, before regenerated particulate material is fed back into the reactor. In that way, a continuous recirculation of the particles through the cleaning apparatus may be achieved, for example as described in International (PCT) Publication No. WO2014/128430A1, the contents of which are incorporated herein by reference. Additionally or alternatively, spent particulate material may be removed for disposal, for example when contaminated to an especially high level and/or damaged. Similarly, it will be appreciated that new, or fresh, particulate material may be added to the reactor to replace particulate material removed for disposal. Particulate material not previously used in the fluidised bed pyrolysis reactor may be referred to herein as fresh particulate material. Preferably, the fluidised bed reactor is configured to operate as a bubbling fluidised bed reactor. Additionally or alternatively, the reactor is configured to that particulate material is withdrawn from the reactor (e.g. from the bottom of the reactor, such as below the distributor) separately from pyrolysis product.

The fluidised bed pyrolysis reactor may preferably comprise a fluidising gas distributor positioned below the fluidised bed zone. Preferably, the distributor is configured so as to allow a portion of the particulate material to fall through the distributor. A portion of the particulate material that has fallen through the distributor may be removed, e.g. through a particulate material outlet, thereby allowing cleaning and/or disposal of the material. Fresh and/or clean material may be added to the pyrolysis reactor, for example fed into the fluidised bed zone of the reactor above the distributor via a fluidised material inlet. Optionally, the fluidised material inlet is located in the fluidised bed zone, e.g. so that fresh and/or clean particularly material is supplied directly into the body of the fluidised bed when the reactor is in operation. Optionally, particulate material withdrawn from below the distributor is cleaned and then the cleaned particulate material is fed back into the pyrolysis reactor, so that a continuous recirculation of the particulate material through a cleaning apparatus may be achieved as described herein.

The distributor may preferably comprise an array of ducts with orifices, for example in their surface, the ducts being configured such that a fluidising medium is fed to the ducts and exits the ducts through the orifices into the reactor, wherein the array of ducts is configured such that particulate material can fall between the ducts. The ducts may for example be arranged in a row or a grid, with the spacing between the ducts being selected so as to allow the particulate material to pass between the ducts. It will be appreciated that steps may be taken to prevent particulate material falling from the fluidised bed falling into, and blocking, the orifices. The orifices may, for example, be in the underside of the ducts. In another example, the orifices may comprise a nozzle comprising a cap to prevent particles blocking the orifice.

Preferably, the pyrolysis reactor includes an outlet, such as a rotary valve, through which, in use, a portion of the particulate material that has fallen through the distributor can be removed, an apparatus for cleaning the particulate material, and an inlet through which cleaned particulate material can be fed back into the pyrolysis reactor. The inlet may preferably be above the distributor in the fluidised bed pyrolysis reactor. Optionally, the distributor defines the bottom of the fluidised bed zone of the reactor.

Any appropriate mechanism for transferring particulate material between the pyrolysis reactor and the cleaning apparatus may be employed. For example, during use, particulate material for cleaning may be collected from the bottom of the pyrolysis reactor and fed to the cleaning apparatus via a withdrawal line. The withdrawal line may include any suitable apparatus for elevating the particulate material, such as a mechanical or non-mechanical apparatus (e.g. a screw conveyer or a pneumatic conveyer).

Cleaned particulate material may be returned from the cleaning apparatus to the pyrolysis reactor via a return line. The return line may be configured to allow cleaned particulate material to return to the pyrolysis reactor substantially under gravity, and/or may comprise any suitable conveying apparatus (such as a screw conveyer or a pneumatic conveyer).

It will be appreciated that the reactor system of the first aspect of the invention may comprise particulate material for forming the fluidised bed in the pyrolysis reactor, the particulate material comprising said particulate material susceptible to inductive heating.

It will be understood that a material, such as a particulate material, that is susceptible to inductive heating is a material which becomes hot when it is exposed to an alternating electromagnetic field. Typically, such materials are electrically conductive and/or ferromagnetic. For example, the particulate material susceptible to inductive heating may be electrically conductive. Without wishing to be bound by theory, it is thought that exposure of electrically conductive material to an alternating electromagnetic field induces eddy currents in the electrically conductive material, leading to heating of the material due to its electrical resistance. Additionally or alternatively, the particulate material susceptible to inductive heating may be ferromagnetic. Without wishing to be bound by theory, it is thought that exposure of ferromagnetic material to an alternating electromagnetic field generates heat by magnetic hysteresis losses. It will be appreciated that a particulate material susceptible to inductive heating may be both electrically conductive and ferromagnetic. In such cases, heating of the material may result both from induced eddy currents and magnetic hysteresis losses. Conversely, it will be understood that a material, such as a particulate material, that is non-susceptible to inductive heating is a material with does not become hot when exposed to an alternating electromagnetic field. For example, such a material is neither electrically conductive (i.e. the material is an electrical insulator) nor ferromagnetic. It will be appreciated that a material non-susceptible to inductive heating may also be described as inductively inert.

Optionally, each particle of particulate material susceptible to inductive heating consists essentially of one or more compounds or elements that are susceptible to inductive heating. It will be understood that a material consists essentially of a given component when the component forms at least 95% by weight of the material. It will be understood that any material said to consist essentially of a component may, for example, consist entirely of that component (i.e. comprise 100% by weight of that component). Alternatively, each particle of particulate material susceptible to inductive heating comprises one or more compounds or elements that are susceptible to inductive heating and one or more compounds or elements not susceptible to inductive heating. For example, each particle may comprise a blend of such compounds/elements, or a shell/core structure having compounds/elements susceptible to inductive heating in the core or shell. Optionally, each particle comprises a majority of compounds/elements susceptible to inductive heating by weight, such at least 75% or at least 90% compounds/elements susceptible to inductive heating by weight, based on the weight of the particle. Optionally, the particulate material susceptible to inductive heating may, for example, comprise or consist essentially of one or more electrically conductive and/or ferromagnetic materials, such as one of more of: one or more electrically conductive and/or ferromagnetic elemental metals; one or more electrically conductive and/or ferromagnetic metal alloys; and one or more electrically conductive and/or ferromagnetic metal oxides. Examples of suitable elements/compounds susceptible to inductive heating include iron and iron oxides (e.g. magnetite, Fe₃O₄). Optionally, the particulate material susceptible to inductive heating comprises or consists essentially of elemental iron and/or one or more iron oxides, such as magnetite. Optionally, the ferromagnetic material has a Curie temperature equal to or greater than the desired operating temperature of the pyrolysis reactor, such as a Curie temperature of at least 400° C., for example at least 550° C.

Optionally, particulate material susceptible to inductive heating comprises or consists essentially of ceramic particles at least partially coated with one or more such electrically conductive and/or ferromagnetic materials. Optionally, particulate material susceptible to inductive heating comprises or consists essentially of one or more molecular sieves comprising one or more such electrically conductive and/or ferromagnetic materials, for example one or more molecular sieves impregnated with one or more such electrically conductive and/or ferromagnetic materials, optionally wherein the one or more molecular sieves are one or more zeolites.

Optionally, the particulate material further comprises particulate material not susceptible to inductive heating. Non-limiting examples of particulate material not susceptible to inductive heating include material that comprises or consists essentially of one or more ceramic particulate materials, one or more silicates, one or more zeolites, and/or one or more aluminium oxides.

Optionally, the particulate material comprises a mixture of particulate material susceptible to inductive heating and material not susceptible to inductive heating. Optionally, in such a mixture, the percentage by weight of the particulate material susceptible to inductive heating is at least 10%, for example at least 20%, such as at least 50%, based on the total weight of particulate material. Additionally, or alternatively, the percentage by weight of the particulate material not susceptible to inductive heating is at least 10%, such as at least 20%, for example at least 40% by weight, based on the total weight of particulate material. Additionally, or alternatively, the particulate material comprises 10% to 90%, such as 20% to 80%, for example 40% to 60% by weight particulate material susceptible to inductive heating, based on the total weight of particulate material. Optionally, in such mixtures, the particulate material susceptible to inductive heating consists essentially of one or more elements/compounds susceptible to inductive heating, for example the particulate material susceptible to inductive heating is iron and/or iron oxide (e.g. magnetite).

Additionally, or alternatively, the particulate material comprises at least 10%, for example at least 20%, such as at least 50% by weight of one or more elements/compounds susceptible to inductive heating, such as electrically conductive and/or ferromagnetic materials, for example iron and/or iron oxide (e.g. magnetite), based on the total weight of particulate material. Additionally, or alternatively, the particulate material comprises at least 10%, such as at least 20%, for example at least 40% by weight of one or more elements/compounds not susceptible to inductive heating. Additionally, or alternatively, the particulate material comprises 10% to 90%, such as 20% to 80%, for example 40% to 60% by weight of one or more elements/compounds susceptible to inductive heating. In such particulate material, the one or more elements/compounds susceptible to inductive heating is iron and/or iron oxide (e.g. magnetite).

An average density of the particulate material may suitably be selected on the basis of promoting the fluidisation of the particulate material within the fluidised bed of the pyrolysis reactor. An average density of the particulate material may, in particular, be selected on the basis of achieving a uniform distribution of fluidising medium across the bed, and thus a uniform heating of the bed. An average, for example the median, density of the particulate material may be in a range of 2 to 7 g/cm³, such as from 4 to 6 g/cm³. The particulate material may comprise two or more materials of different densities. For example, this may be the case where the particulate material comprises both material susceptible to inductive heating and material not susceptible to inductive heating, as described herein. A single particle of particulate material may comprise two or more materials of different densities. A particle of particulate material may be porous, and/or hollow, leading to variations in density throughout its structure, and influencing its overall average density. A first particle may have a different average density compared to a second particle. The maximum difference in density within a particle, or between particles, may be in a range of 0 to 5 g/cm³, such as 0.5 to 3 g/cm³, such as from 1 to 2 g/cm³. In this way, a substantially uniform density distribution may be achieved, so as to achieve a uniform distribution of the fluidising medium across the bed.

An average particle size of particulate material may suitably be selected on the basis of promoting the fluidisation of the particulate material within a fluidised bed of the pyrolysis reactor. An average particle size may, in particular, be selected on the basis of achieving a uniform distribution of fluidising medium across the bed, and thus a uniform heating of the bed. An average, for example the median, particle diameter may be in a range of from 0.06 mm to 1 mm, such as 0.06 to 0.5 mm, for example 0.1 to 0.5 mm, e.g. 0.2 mm. The particulate material may comprise particles of varying sizes. For example, this may be the case where the particulate material comprises both material susceptible to inductive heating and material not susceptible to inductive heating. The maximum difference in size between particles may be in a range of 0 to 0.8 mm, for example 0.02 to 0.4 mm, for example 0.05 to 0.1 mm. It may be that greater size differentials between particles are utilised when there is a greater density differential between particulate materials. For example, a larger difference in particle size may be used to help maintain consistency through the bed when there is a larger difference in particulate material density. In this way, a substantially uniform mass distribution may be achieved throughout the bed, which may in turn help to achieve a uniform distribution of the fluidising medium across the bed.

Optionally, the particulate material may be substantially chemically inert under the conditions typically found within the fluidised bed of a fluidised bed pyrolysis reactor. Advantageously, the reactivity of the particulate material under these conditions may be such as to substantially not affect pyrolysis of the carbonaceous feed.

Where reference is made herein to an induction heater assembly configured to inductively heat particulate material susceptible to inductive heating, it will be appreciated that the assembly is configured to directly heat electrically conductive particles themselves by induction, for example by inducing eddy currents and/or magnetic hysteresis losses in the particulate material. It will be appreciated that this may be in contrast to (for example) an induction heater assembly which heats an inductively susceptible reactor shell (directly) by induction, so that the reactor shell can transfer heat by conduction and convection to particulate material in a fluidised bed, thus heating particulate material as an indirect result of induction. Preferably, the reactor system of the first aspect of the invention is configured so that (during use) only the particulate material susceptible to inductive heating is directly heated by induction.

As used herein, an induction heater assembly preferably comprises both an induction generator and at least one induction emitter, such as an induction coil. It will be appreciated that additional induction emitters (e.g. additional induction coils) may be added, for example to increase heating capacity, and/or to facilitate fine-tuned control of temperature in different parts of a reactor.

In the reactor system of the first aspect of the invention, a pyrolysis induction heater assembly is configured to inductively heat particulate material susceptible to inductive heating in the fluidised bed of the pyrolysis reactor. Optionally, the pyrolysis induction heater assembly comprises at least one induction emitter (e.g. a coil) positioned around (e.g. wrapped around) a heating chamber configured to contain said particulate material. Optionally, the pyrolysis induction heater assembly comprises a plurality of induction emitters (e.g. coils) positioned around (e.g. wrapped around) the heating chamber.

Additional emitters may help increase heating capacity, add redundancy and/or improve control of heating. Optionally, each of the plurality of emitters is independently controllable.

As described herein, preferably, the reactor system of the first aspect of the invention is configured so that (during use) only the particulate material susceptible to inductive heating is directly heated by induction. Preferably, the reactor system is configured so that no surfaces of the heating chamber are directly heated by induction or so that there occurs substantially no (or only minor) direct heating by induction of surfaces of the heating chamber. Any direct inductive heating of surfaces of the heating chamber is preferably outweighed by (especially, is negligible in comparison with) the direct inductive heating of the particulate material. The surfaces of the heating chamber may for example comprise only materials which are not electrically conductive and/or ferromagnetic; or may optionally comprise materials with only trace or only minor amounts of components that are electrically conductive and/or ferromagnetic. Optionally, where there is direct inductive heating of surfaces of the heating chamber, it may be insufficient materially to affect the conditions of the reactor system.

Optionally, the pyrolysis reactor comprises a shell defining the heating chamber. Preferably, the reactor system is configured so that (during use) the shell is not directly heated by induction, or so that there occurs substantially no (or only minor) direct heating by induction of the shell. Optionally, the shell is made from an inductively inert material (such as a refractory material). Additionally or alternatively, the shell is optionally made from a thermally insulating material. Advantages of not heating the shell directly by induction may include that the shell does not become excessively hot during use, so that less heat is lost to the surrounding environment. Directly inductively heating the particulate material, instead of the shell, may provide more uniform heating throughout the bed; may promote a more efficient heating rate; and/or may reduce the risk of cold spots forming in the bed (which can lead to the formation of blockages in the bed). When an inductively inert refractory material is able to be used in forming the shell, this can further reduce heat loss to the surrounding environment.

Optionally, the pyrolysis reactor comprises an inner shell defining the heating chamber and an outer shell disposed around the inner shell. Optionally, the outer shell is spaced apart from the inner shell. Optionally, the outer shell is spaced apart from the inner shell, separated from it by a thermally insulating material. Preferably, the reactor system is configured so that (during use) the inner shell is not directly heated by induction, or so that there occurs substantially no (or only minor) direct heating by induction of the inner shell. Optionally, the inner shell is made from an inductively inert material (such as a refractory material). Additionally or alternatively, the inner shell is optionally made from a thermally insulating material. Preferably, the reactor system is configured so that (during use) the outer shell is not directly heated by induction, or so that there occurs substantially no (or only minor) direct heating by induction of the outer shell. Optionally, the outer shell is made from a metal, such as steel. It will be appreciated that when the outer shell is made from a material susceptible to inductive heating, it may for example be positioned outside the field of the induction heater assembly; in this way, the reactor system may be configured such that the outer shell is not directly heated by induction. Thus, preferably, both the inner shell and the outer shell are configured to not be directly heated by induction or to be substantially not directly heated by induction, or to be heated directly by induction, but only to a minor degree. Advantages of not heating the shells directly by induction may include advantages similar to, or the same as, those described hereinabove. The induction emitter or emitters may be an induction coil or coils. An induction coil may be wound, so as to surround a fluidised bed zone of a fluidised bed reactor, in a number of different configurations, for example configurations with varying numbers of turns. The coil may comprise any conductive material, preferably copper. It will be appreciated by those of ordinary skill in the art that an induction coil may, itself, heat up during use, which may be undesirable; the coil may therefore be cooled by any suitable known method, for example a cooling jacket. The length and thickness of a coil may suitably be selected according to what is known to those of ordinary skill in the art and what is commercially available. Optionally, the induction emitter (such as a coil) is arranged outside the shell (for example wrapped around the shell). Where an inner and outer shell are present, optionally the induction emitter is arranged outside the inner shell (for example wrapped around the inner shell). It will be understood that in such an arrangement, the reaction chamber is positioned on the inside of the (optionally, inner) shell. It may be that, when the (optionally, inner) shell is made from a thermally insulating material, positioning the emitter outside the (optionally, inner) shell helps to insulate the emitter from high temperatures present in the reactor, which may help to protect the emitter from premature degradation.

The configuration of one or more induction emitters in an induction heater assembly may, in particular, be selected on the basis of achieving a uniform heating of the fluidised bed of the reactor, during use.

For example, an induction coil may be arranged in series along all, or a majority of, the height of a fluidised bed zone of the reactor. Likewise, where more than one coil is present, these may be induction coils arranged in series along all, or a majority of, the height of the fluidised bed zone. Alternatively, the coil or coils may be arranged only near the bottom of the fluidised bed zone, and away from its top. For example, where the fluidised bed zone has a height H, the coil or coils may optionally be arranged from the bottom of the fluidised bed zone (for example, as defined by the position of a distributor, as described herein) only up to a height of H/2, H/4, or H/8.

Where more than one induction coil is present, the induction heater assembly is optionally configured so that alternating current supplied to each induction coil may be selected independently, thereby controlling independently the heating achieved by each coil. For example, where it is desirable to heat a first area of the fluidised bed of the reactor to a higher temperature than a second area, the power (e.g. frequency of current) supplied to a coil surrounding the first area may be selected to be higher than the power (e.g. frequency of current) supplied to a coil surrounding the second area.

In a fluidised bed of a reactor which is fluidised by fluidising gas from a distributor, it may be that areas of the bed closest to the distributor tends to be cooler than areas of the bed further away from the distributor. Therefore, one or more coils surrounding areas of the bed closest to the distributor may be supplied with a higher frequency of current than one or more coils surrounding areas of the bed further away from the distributor, to ensure the overall temperature throughout the bed remains substantially uniform. For example, where the fluidised bed zone has a height H, only a coil or coils which are arranged from the bottom of the fluidised bed zone (for example, as defined by the position of a distributor, as described herein) up to a height of H/2, H/4, or H/8, may be supplied with the higher frequency of current.

It will be understood that one or more sensors for measuring a parameter (e.g. temperature, pressure and/or oxygen concentration, particularly temperature) may be positioned in the reactor, for example in the freeboard zone, or in an outlet from the freeboard zone. It will be understood that multiple different sensors may be mounted as a sensor array on a common support. For example, temperature and/or gas and/or pressure sensors may be mounted together at the same position in the reactor.

Optionally, the reactor system comprises a control system, such as a control system configured to communicate with the one or more sensors. Preferably, the one or more sensors include one or more temperature sensors for measuring temperature in the fluidised bed zone and/or the freeboard zone of the reactor (such as one or more intrusive temperature sensors).

Optionally, the control system is configured to control operation of an induction heater assembly in dependence on the temperature measured by said one or more temperature sensors. Optionally (where more than one induction emitter, e.g. induction coil, is present) the control system may be configured to independently control operation of each of several induction emitters (e.g. coils) in dependence on the temperature measured by said one or more temperature sensors. For example, the control system may be configured to independently control the frequency of current supplied to each induction emitter (e.g. coil) in dependence on the temperature measured by said one or more temperature sensors. In this way, inductive heating of the fluidised bed of the reactor may be controlled in dependence on the temperature of the, or of specific areas of the, fluidised bed and/or the freeboard zone of the reactor.

Optionally, carbonaceous waste may be supplied to the pyrolysis reactor only when the pyrolysis reactor temperature falls within pre-determined limits. For example, flow of waste may be prevented when the pyrolysis reactor fluidised bed temperature and/or the freeboard temperature is below a minimum temperature threshold TT1, and/or when the pyrolysis reactor fluidised bed temperature and/or the freeboard temperature is above a maximum temperature threshold TT2. Preferably, TT1 is at or above the cracking temperature of the carbonaceous waste, and/or TT2 is below the temperature at which excessive cracking of carbonaceous waste would be expected. Optionally, TT1 is in the range of from 350° C. to 600° C., such as 400° C. to 500° C., and TT2 is in the range of from 450° C. to 850° C., such as 600° C. to 800° C. Such a control system may assist in prevent overheating of the reactor system. Additionally or alternatively, increasing the rate at which carbonaceous waste is supplied into the pyrolysis reactor may lead to a decrease in bed temperature.

In a second aspect, the present invention provides a method of treating waste comprising carbonaceous waste by pyrolysis in a reactor system according to the first aspect of the invention to form a pyrolysis product, wherein the method comprises fluidising particulate material comprising particulate material susceptible to inductive heating in the fluidised bed zone of the fluidised bed pyrolysis reactor; operating the pyrolysis induction heater assembly to inductively heat the particulate material susceptible to inductive heating to a temperature in a range of from 350° C. to 800° C.; and contacting the carbonaceous waste with the heated particulate material in the fluidised bed zone of the pyrolysis reactor, thereby pyrolysing the carbonaceous waste to form the pyrolysis product. Optionally, the waste comprises plastic waste, such as mixed plastic waste or segregated plastic waste (such as polystyrene plastic waste).

Optionally, the method additionally comprises: transferring particulate material to be cleaned from the fluidised bed pyrolysis reactor to a cleaning apparatus as described in relation to the first aspect of the invention.

In a third aspect, the present invention provides the use of particulate material susceptible to inductive heating, and optionally particulate material not susceptible to inductive heating, as defined herein, in a reactor system according to the first aspect of the invention and/or in a method according to the second aspect of the invention.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIG. 1 shows a schematic view of a reactor system for pyrolysis of carbonaceous waste, according to an embodiment of the invention;

FIG. 2 shows a schematic view of a reactor system for pyrolysis of carbonaceous waste, according to another embodiment of the invention;

FIG. 3 shows a schematic view of a reactor system for pyrolysis of carbonaceous waste, according to another embodiment of the invention;

FIG. 4 shows a schematic view of a reactor system for pyrolysis of carbonaceous waste, according to another embodiment of the invention;

FIGS. 5A and 5B show a schematic view of the experimental set-up used to directly heat particulate material by induction (FIG. 5A); and a close-up schematic view of the induction coil and a section of quartz tube containing the particulate material to be tested (FIG. 5B);

FIG. 6 shows a graph plotting change in temperature over time as a particulate material is heated by direct induction to its maximal temperature;

FIG. 7 shows a graph plotting change in temperature over time during direct inductive heating for two different particulate materials;

FIGS. 8A to 8E show photographic images of mixtures of iron filings and non-conductive particulate material following inductive heating;

FIG. 9 shows a graph plotting the change in maximum temperature over applied current for a sample of magnetite powder;

FIGS. 10A and 10B show standard and semi-logarithmic graphs, respectively, plotting the variation of temperature with time for a sample of magnetite heated under a range of different induction currents (see legend);

FIGS. 11A and 11B show standard and semi-logarithmic graphs, respectively, plotting the variation of temperature with time for differing masses of particulate material (magnetite), at a fixed current;

FIG. 12A shows a graph comparing final temperatures for inductively heated magnetite-TG mixtures of varying relative concentration;

FIG. 12B shows a graph comparing final temperatures for inductively heated iron-TG mixtures of varying relative concentration;

FIG. 13 shows a schematic view of the experimental set-up used to pyrolyse carbonaceous waste material by induction;

FIG. 14 shows the results of a gas chromatography-mass spectrometry (GC-MS) experiment to determine the composition of the pyrolysis product;

FIG. 15A shows the results of a simulated distillation (SIM-DIS) experiment comparing the composition of a product obtained from pyrolysis of carbonaceous waste by induction with a product obtained from pyrolysis of carbonaceous waste using conventional heating means (heat of combustion); and

FIG. 15B shows a table of data points for the graph of FIG. 15A.

### DETAILED DESCRIPTION

### Description of the Figures

Whilst the present invention has been described and illustrated with reference to particular embodiments, it will be appreciated by those of ordinary skill in the art that the invention lends itself to many different variations not specifically illustrated herein. By way of example only, certain possible variations will now be described.

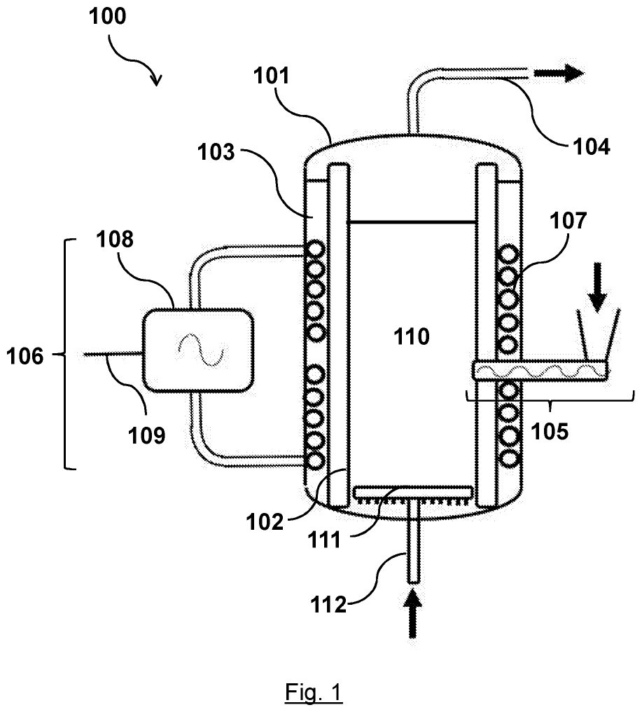

In FIG. 1, a reactor system 100 for pyrolysis of carbonaceous waste is shown according to an embodiment of the invention. The system 100 comprises a pyrolysis reactor having a steel outer shell 101. Outer shell 101 is configured to withstand high pressures under which pyrolysis may be conducted (for example, the reactor may be configured to operate at a pressure of from 0.1 to 2 barg), and encloses a reaction chamber containing a fluidised bed zone 110. The reaction chamber is lined with an electrically inert, ceramic liner 102. An intermediate electrically and thermally insulating layer 103 is disposed between outer shell 101 and reaction chamber 102. It will be appreciated that any suitable known materials, such as a ceramic materials, may be used to form the liner 102 and the insulation layer 103. A gas outlet 104 delivers pyrolysis gas from the reactor to downstream processing apparatus (not shown in FIG. 1). Feed system 105 supplies a feed, in this case mixed plastic waste but it will be appreciated that other feed materials could be used, to the reaction chamber. Any suitable known feed system may be used. In the system depicted in FIG. 1, the feed system 105 comprises a feed conduit fitted with an auger for conveying feed material from a collection hopper into the reactor. An example of a suitable feed system is disclosed in International (PCT) Publication No. WO2021/089995A1, the contents of which are incorporated herein by reference. It will be appreciated that other feed systems may be employed, for example depending on the nature of the carbonaceous feed material. An example of a feed system suitable for feeding a fluid feed is disclosed in International (PCT) Publication No. WO2021/074626A1, the contents of which are incorporated herein by reference. The reactor system 100 further comprises an induction heater assembly 106 comprising induction coil 107 and induction generator 108. It will be appreciated that any known suitable induction generator may be used together with any known suitable induction coil(s). In the system 100 of FIG. 1, a single copper induction coil 107 is wound around a heating chamber that contains the fluidised bed zone 110 of the pyrolysis reactor, disposed between outer shell 101 and reaction chamber 102. It will be appreciated that additional coils may be added, for example to increase heating capacity and/or to enlarge the heating chamber. Power is supplied to induction generator 108 via power supply line 109 from a power supply (not shown in FIG. 1). Induction generator 108 generates alternating current (AC) and transfers AC to the induction coil 107. Induction coil 107 at least partially surrounds chamber 102. In particular, induction coil 107 is configured, in use, to at least partially surround fluidised bed zone 110. In use, fluidised bed zone 110 contains a fluidised bed of particulate material comprising particulate material susceptible to inductive heating, the particulate material being fluidised by injection of fluidising gas into chamber 102 via distributor 111, which is supplied with fluidising gas via fluidising gas line 112. Any suitable fluidising gas and fluidising gas distributor may be used, such as that described in International (PCT) Publication No. WO2014/128430A1, the contents of which are incorporated herein by reference. In use, particulate material susceptible to inductive heating is directly inductively heated by induction coil 107. In turn, the heated particulate material heats the remaining contents of reaction chamber 102 in fluidised bed zone 110, including the feed (e.g., pyrolysis feedstock) by conduction.

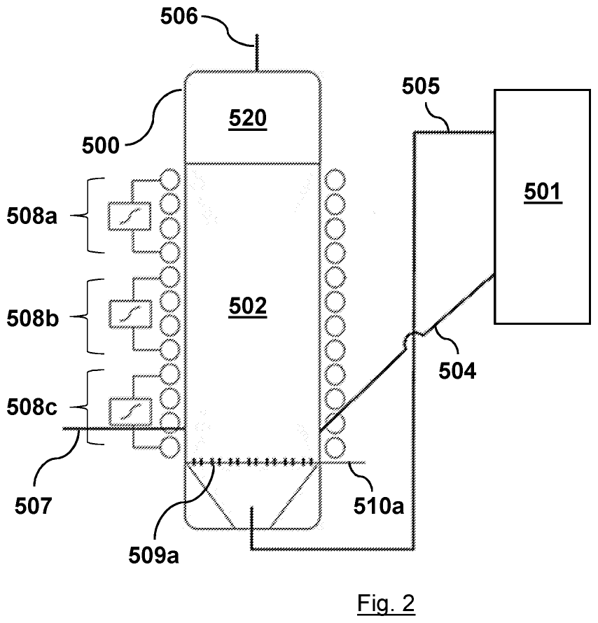

In FIG. 2, a dual fluidised bed pyrolysis apparatus is shown comprising a fluidised bed pyrolysis reactor 500, and a cleaning apparatus 501. The pyrolysis reactor 500 comprises a fluidised bed zone 502 and a freeboard zone 520. During use, fluidised bed zone 502 contains a fluidised bed of particulate material comprising particulate material susceptible to inductive heating, the particulate material being fluidised by injection of fluidising gas via distributor 509a, which is supplied with fluidising gas via fluidising gas line 510a. Any suitable fluidising gas distributor may be used with the reactor assembly. Spent particulate material is collected from the bottom of the pyrolysis reactor 500 and fed to cleaning apparatus 501 via withdrawal line 504. Optionally, the spent particulate material is conveyed upwards to an upper portion of the cleaning apparatus 501 as it travels along withdrawal line 504. The withdrawal line 504 may include any suitable apparatus for elevating the particulate material, such as a mechanical or non-mechanical apparatus (e.g. a screw conveyer or a pneumatic conveyer). Regenerated particulate material is returned from cleaning apparatus 501 to pyrolysis reactor 500 via return line 505. Return line 505 may be configured to allow regenerated particulate material to return to pyrolysis reactor 500 substantially under gravity, and/or may comprise any suitable conveying apparatus (such as a screw conveyer or a pneumatic conveyer). During use, feed material is pyrolysed in the pyrolysis reactor 500 to form a pyrolysis product vapour. The pyrolysis product vapour is withdrawn from the top of the pyrolysis reactor 500 via line 506, and then passed through a product cleaning device (not shown; e.g. a hot gas filter) which separates unwanted contaminants from the pyrolysis product vapour. The cleaned pyrolysis product vapour is then passed to a condenser assembly (not shown) to separate the pyrolysis product vapour into a plurality of fractions, each of which are separately collected. The use of a condenser assembly is optional, and it will be appreciated that the pyrolysis product may be separated into any number of fractions, depending on the requirements of the operator. Feed material, which may be carbonaceous waste, for example plastic waste, is supplied into the pyrolysis reactor 500 via a feed system 507. The dual fluidised bed pyrolysis apparatus further comprises induction heater assemblies 508a-f, comprising induction coils and induction generators. In the dual fluidised bed pyrolysis apparatus of FIG. 2, multiple copper induction coils are wound around heating chambers that contain the fluidised bed zone 502 of the pyrolysis reactor. It will be appreciated that the number of coils may, however, be varied. In use, particulate material susceptible to inductive heating is directly inductively heated by the induction coils. In turn, the heated particulate material heats the remaining contents of the fluidised bed zone 502, including the feed (e.g., pyrolysis feedstock) by conduction.

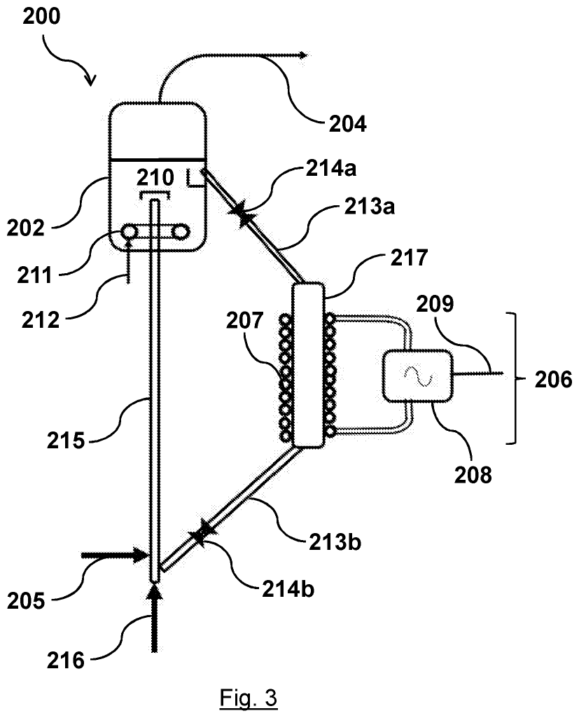

In FIG. 3, a reactor system 200 for pyrolysis of carbonaceous waste is shown, according to another embodiment of the invention. Features shown in FIG. 3 that have substantially the same function as features shown in FIG. 1 are provided with the same reference numerals (with the prefix ‘1-’ replaced by the prefix ‘2-’). The system 200 comprises a pyrolysis reactor having reaction chamber 202, which contains fluidised bed zone 210. In use, fluidised bed zone 210 contains a fluidised bed of heated particulate material comprising particulate material susceptible to inductive heating, fluidised by injection of fluidising gas into chamber 202 via distributor 211, which is supplied with fluidising gas via fluidising gas line 212. Spent particulate material is transferred from the top of fluidised bed zone 210 of reaction chamber 202, via withdrawal line 213a, to vessel 217, with the aid of gravity. Slide valve 214a controls flow of material between reaction chamber 202 and vessel 217. The reactor system 200 further comprises an induction heater assembly 206, comprising induction generator 208 and induction coil 207, which at least partially surrounds an electrically inert, ceramic vessel 217. In use, particulate material susceptible to inductive heating contained in vessel 217 is directly inductively heated by the induction coil 207. Heated particulate material is transferred from vessel 217 to riser 215 via supply line 213b, with the aid of gravity. Slide valve 214b controls flow of material between vessel 217 and riser 215. Feed system 205 supplies a feed, for example pyrolysis feedstock, to riser 215, which is carried, along with heated particulate material, with the aid of lift gas supplied by lift gas supply line 216, into reaction chamber 202. Any suitable known riser may be used. Thus, in use, heated particulate material heats the feed (e.g., pyrolysis feedstock) by conduction. Gas outlet 204 delivers pyrolysis gas from reaction chamber 202 to downstream processing apparatus (not shown in FIG. 3).

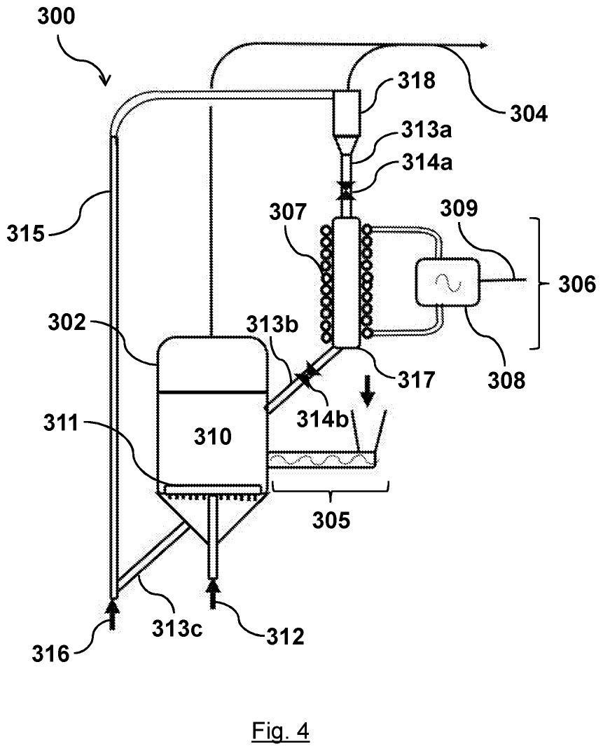

In FIG. 4, a reactor system 300 for pyrolysis of carbonaceous waste is shown, according to another embodiment of the invention. Features shown in FIG. 4 that have substantially the same function as features shown in FIG. 3 are provided with the same reference numerals (with the prefix ‘2-’ replaced by the prefix ‘3-’). The system 300 comprises a pyrolysis reactor having reaction chamber 302, which contains fluidised bed zone 310. In use, fluidised bed zone 310 contains a fluidised bed of heated particulate material comprising particulate material susceptible to inductive heating, fluidised by injection of fluidising gas into chamber 302 via distributor 311, which is supplied with fluidising gas via fluidising gas line 312. Spent particulate material falls below distributor 311 and is transferred from reaction chamber 302 via withdrawal line 313c to riser 315. The particulate material is carried with the aid of lift gas, supplied by lift gas supply line 316, to cyclone 318 and thence via line 313a into electrically inert, ceramic vessel 317. Slide valve 314a controls flow of material between cyclone 318 and vessel 317. The reactor system 200 further comprises an induction heater assembly 306, which comprises induction generator 308 and induction coil 307, which at least partially surrounds vessel 317. Thus, in use, particulate material susceptible to inductive heating contained in vessel 317 is directly inductively heated by the induction coil 307. Heated particulate material is transferred from vessel 317 to fluidised bed zone 310 of reaction chamber 302 via supply line 313b, with the aid of gravity. Slide valve 314b controls flow of material between vessel 317 and vessel 302. Feed system 305 supplies a feed, for example pyrolysis feedstock, to fluidised bed zone 310 of reaction chamber 302. Thus, in use, heated particulate material in fluidised bed zone 310 heats the feed (e.g., pyrolysis feedstock) by conduction. Gas outlet 304 delivers pyrolysis gas from reaction chamber 302 to downstream processing apparatus (not shown in FIG. 4).

### EXAMPLES

### Inductive Heating of Particulate Material

An investigation was carried out into the use of inductive heating to directly heat particulate media in a fluidised bed for plastic waste thermal cracking. Direct inductive heating contrasts to conventional indirect inductive heating, where induction is used to heat one or more solid conducting or semiconducting materials (for example, reactor walls, or rods positioned within a reactor) which in turn heat a fluid and/or particulate medium in contact with said walls/rods.

The following tests were performed to demonstrate that induction heating can be used to directly heat a particulate medium to a temperature sufficient to induce pyrolysis, and which particulate materials are susceptible to inductive heating.

### Experimental Set-Up

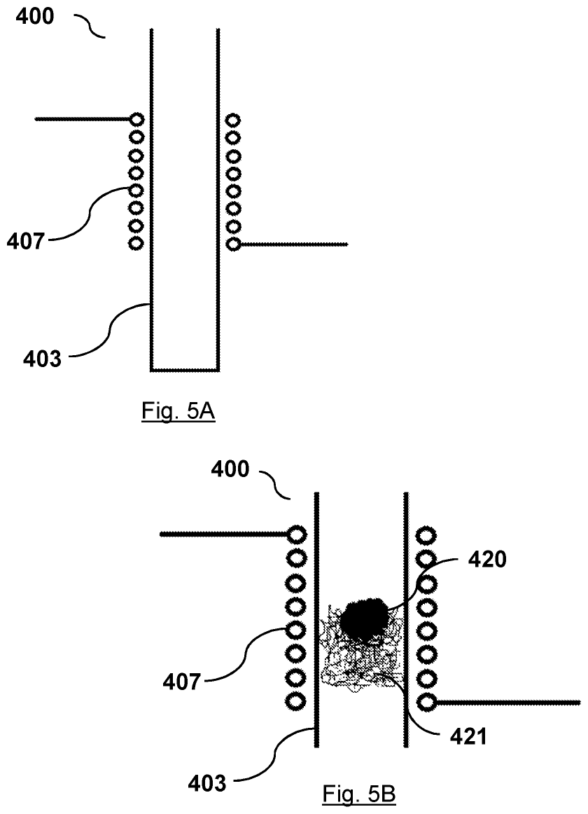

Tests were performed using apparatus 400 (see FIGS. 5A and 5B) including a simple induction system (Ambrell Easy Heat 2.4 kW Induction Heating System). The material to be heated 420 is placed within a hollow quartz tube 403 surrounded by an induction coil 407. For the experimental system, quartz was used rather than other, more commonly available materials, to provide a margin of safety should the material reach especially high temperatures such as about 800° C. Quartz is not susceptible to inductive heating. It will be appreciated that other materials may be suitable in a reactor with appropriate temperature control.

In each experiment performed, a sample (typically of size 6 g, although a variety of masses were tested, as set out in further detail herein) of a given particulate material 420 was placed in the vertically oriented quartz tube 403, and was held in place by quartz wool 421. The tube 403 was positioned such that the particulate material to be tested 420 lay at the axial and radial centre of the induction coil 407, so as to maximise heating efficiency. A calibrated Calex™ PMU201 USB infra-red temperature sensor (not shown; obtainable from RS Components Ltd. Birchington Road, Corby, Northants, NN17 9RS, UK) was placed orthogonal to the material to be tested 420, such that its temperature may be directly measured and recorded.

### Experimental Procedure

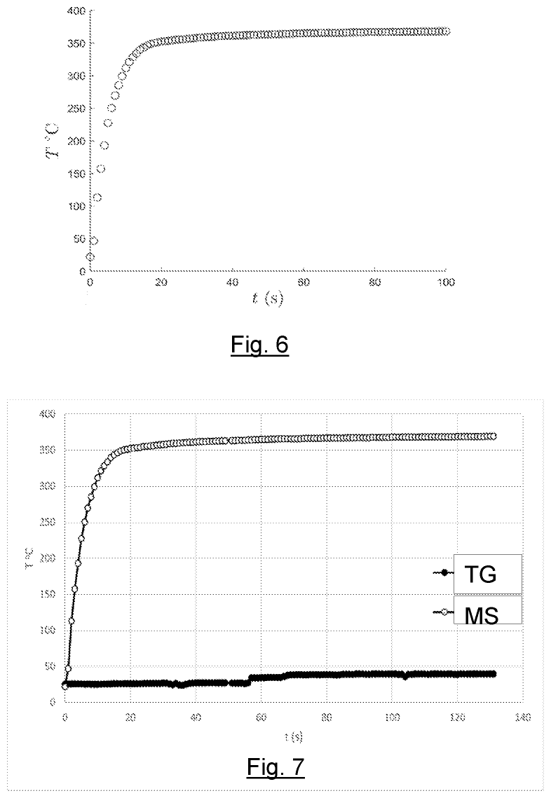

In each experiment performed, a chosen sample of material was loaded into the system, and the IR sensor was aimed directly at the sample. A chosen, constant alternating current (and thus power) was then applied to the electro-induction coil. The voltage and frequency applied were determined autonomously by the system. As the system was heated, particulate temperature was logged, in real time, by the sensor. Each experiment was stopped (i.e., the current was reduced to zero) when either: a) the temperature reached an apparent asymptote, implying no further increase in temperature would be achieved for the current settings; or b) the temperature exceeded 800° C., thus approaching the safe limit for the quartz glass tubing. For comparison, a graph plotting change in temperature with time for a comparative system approaching its asymptotic maximal temperature is shown in FIG. 6 (the data for the graph of FIG. 6 was collected from a sample of 6 g of magnetite contained in a quartz glass tube).

### Materials

Three particulate materials, and various binary combinations thereof, were tested in varying relative combinations. The materials tested were:
Thermogranules (TG)-non-susceptible to inductive heating ceramic particulate material comprising a mixture of a metal oxide and a metal silicate, having a density of 1.5 to 2 g/cm³.
Magnetite (MS, metallic sand) (Fe₃O₄)
Iron filings (Fe) (elemental)

### Comparing Particulate Materials

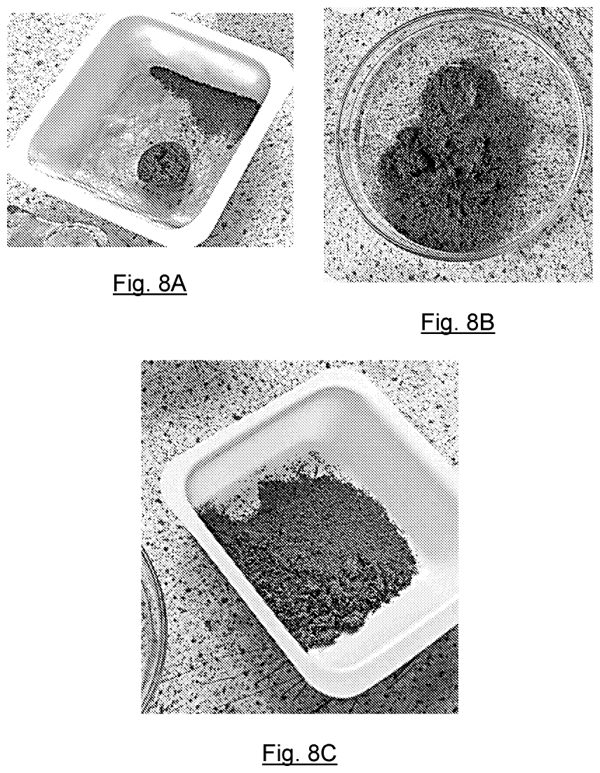

Using the methodology described under Experimental procedure above, temperature against time profiles were measured for each of the particulate materials. For all tests, the electroinduction apparatus was set to maximal current (500 A) and thus power (2.4 kW). The results of the tests with thermogranules and magnetite are shown in FIG. 7. During testing, it was found that altering the position of the particulate material relative to the induction coil could lead to changes in peak temperature (the further the material from the centre position relative to the coil, the lower the peak temperature). However, in such cases the heating trend remained similar. As shown in FIG. 7, MS was observed to exhibit a significant increase in temperature.

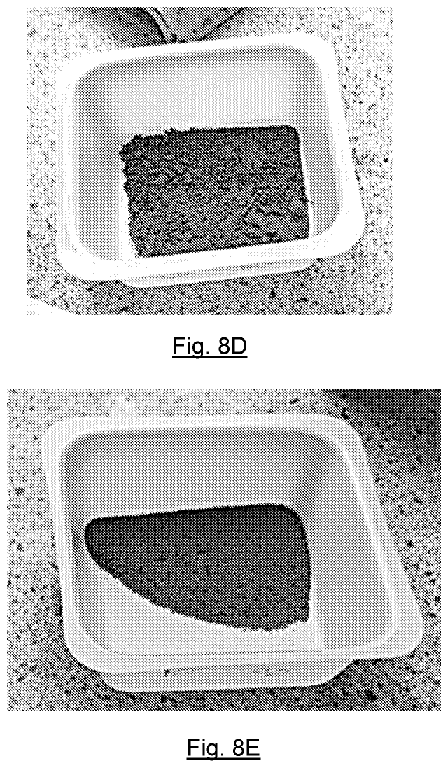

Iron filings were also tested as a particulate material. This material was found to rapidly heat up to a maximum temperature far above 800° C. The experiment was shut down, as a safety measure, before the asymptotic maximum for iron filings was reached. Iron filings are therefore a promising particulate material in terms of temperatures achieved. However, when heated to high temperatures, the iron filing particles were found to fuse together and form larger agglomerates. Remedies to this were explored. FIGS. 8A to 8E show photographs of samples of various fractional concentrations of iron filings and thermogranules after being subjected to inductive heating. Systems containing larger percentages of iron filings (FIGS. 8A to 8C, particularly FIG. 8A) show a greater tendency to form large, rock-like agglomerates than those containing a greater relative proportion of thermogranules (FIG. 8E). Elemental iron is also expected to be somewhat reactive with pyrolysis feed materials and/or products, and so its use may lead to unwanted reactions within a pyrolysis system if used at high concentration. A combination of iron filings with other materials is therefore a promising option for use as particulate material in a fluidised bed pyrolysis reactor, wherein the iron portion of the particulate material is directly heated by induction.

### Influence of Current

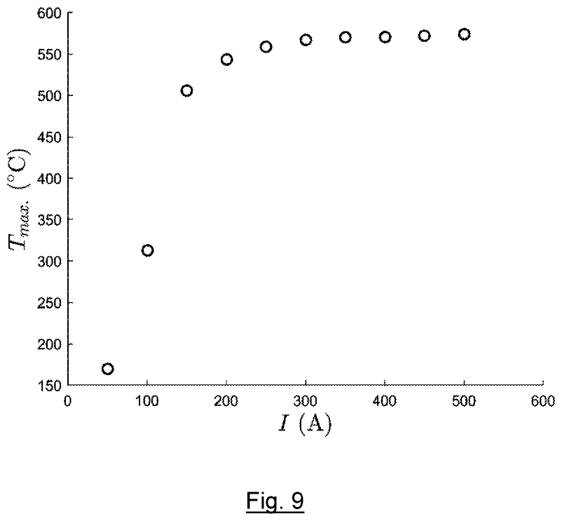

Having established the viability of magnetite and iron filings in particular, the influence of applied current on the maximum temperature reached was investigated. The relation between maximal (asymptotic) temperature achieved and input current for a 6 g sample of magnetite can be seen in FIG. 9. There was a clear approach to an asymptotic value of approx. 570° C. as the current (and thus power) were increased.

That asymptotic behaviour offers the possibility of heating the sample to a temperature suitable for pyrolysis, with low power draw (less than 1 kW). Moreover, the fact that the temperature value remains constant even as current and power are increased suggests that a consistent temperature may be conveniently maintained using inductive heating.

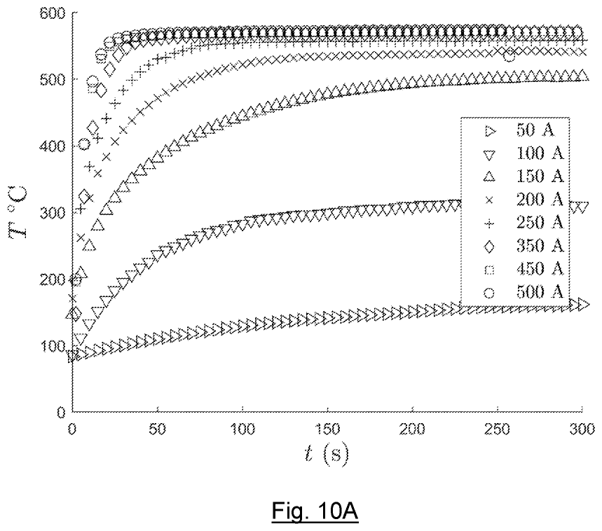

A similar trend was observed for iron filings, although for current above approx. 250 A the readings were, as previously, off the measurable scale. Although the maximum temperature achieved by the materials is observed to reach saturation at approximately 250 A, the rate at which the material is heated continues to increase with increasing current for a significantly larger range of currents, as illustrated in FIGS. 10A and 10B.

### Influence of Material Mass

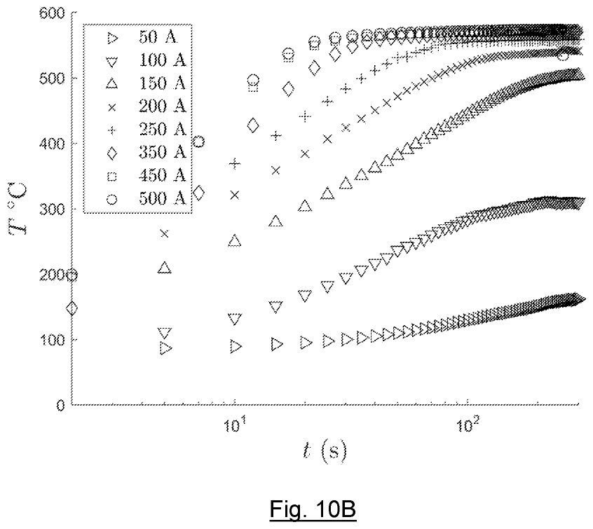

The data above were acquired at a fixed mass of material (6 g). Tests were also conducted to determine the influence of sample mass. Temperature against time profiles for a variety of masses of magnetite, in a range of from 6 to 14 g (the upper bound of 14 g corresponding to the maximum volume of material which would fit within the experimental induction coil) are shown in FIGS. 11A and 11B. Other than the presence of noise in some readings, the temperature vs. time profiles remains strikingly similar, even as the mass of material is more than doubled. It is believed that this indicates that direct induction heating of particulate material is not limited to small samples, but rather is scalable to larger, industrial systems.

### Investigating Mixed Materials

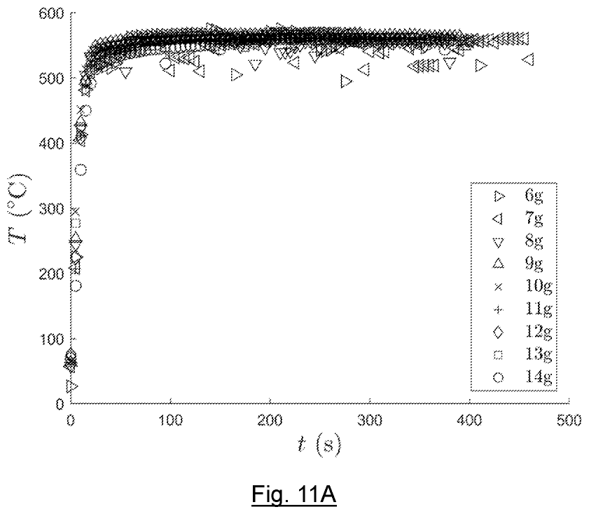

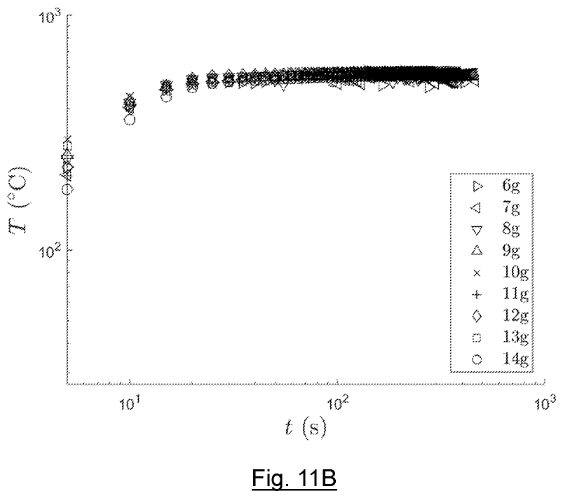

Experiments were performed using mixtures of particulate material susceptible to inductive heating with particulate materials not susceptible to inductive heating to assess the effects of changing relative concentrations. FIG. 12A shows the final temperature for a variety of mixtures of MS and TG (the latter of which is not susceptible to inductive heating). As the proportion of magnetite is reduced, the final temperature reached is reduced. Nevertheless, reasonable degrees of heating were still observed for volume fractions of magnetite of above approx. 10% v/v. Although, in the present set-up, these lower-concentration mixtures acquire steady-state temperatures of under 450° C., it is expected that improved insulation would allow higher steady-state temperatures to be reached. FIG. 12B shows the final temperatures for a variety of mixtures of Fe and TG. Again, a largely similar trend was observed, except that the final temperature was higher for the Fe/TG mixtures than MS/TG mixtures. Note that, as previously, the asymptotic temperature could not be safely reached for the Fe-TG mixtures above 70% Fe.

### Conclusions

Magnetite and iron filings have been demonstrated to be promising materials susceptible to inductive heating for use in an inductively heated fluidised bed pyrolysis reactor. Mixtures of those materials with inert bed materials can also be inductively heated effectively. It is believed that the apparent invariance of both heating rate and maximum temperature with the mass of material being heated is evidence of the scalability of this heating method. Further evidence for scalability lies in the fact that even relatively low concentrations of material susceptible to inductive heating can produce significant heating when mixed with comparatively large volumes of material not susceptible to inductive heating.

### Pyrolysis of Carbonaceous Waste by Induction

The pyrolysis of polyolefin chips in a bed of directly inductively heated particulate material was investigated.

### Experimental Set-Up

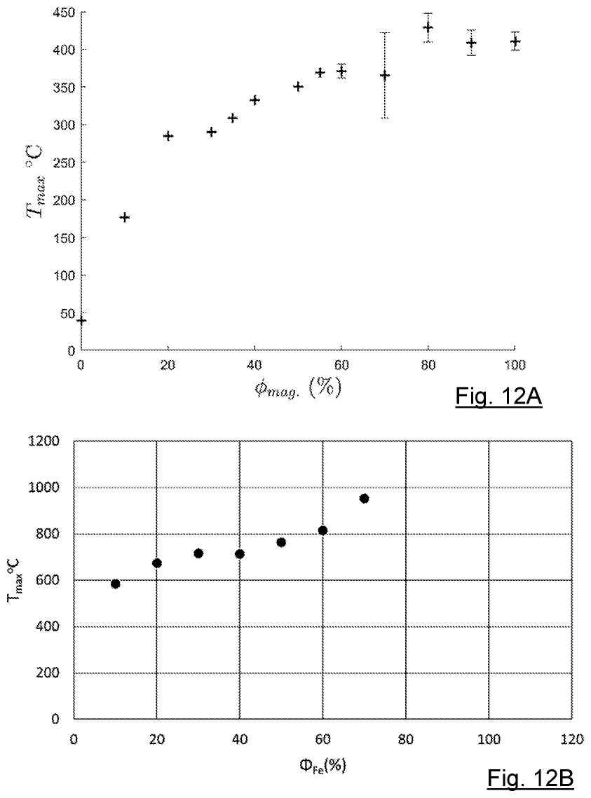

Tests were performed using apparatus 1300 (see FIG. 13) including a simple induction system (Ambrell Easy Heat 3 kW Induction Heating System, 3 cm diameter coil). Hollow quartz tube 1303 (of outside diameter 22 mm and length 30 cm; held in place by clamp 1322) was surrounded by the induction coil 1307. As before, for the experimental system, quartz was used rather than other, more commonly available materials, to provide a margin of safety should the material reach especially high temperatures such as about 800° C. Quartz is not susceptible to inductive heating. It will be appreciated that other materials may be suitable in a reactor with appropriate temperature control.

In each experiment performed, a mixture 1320 comprising 1 g of polyolefin chips and 12 g of particulate material susceptible to inductive heating was placed in the vertically oriented quartz tube 1303 and held in place by quartz wool 1321a. The tube 1303 was positioned such that the particulate material 1320 lay at the axial and radial centre of the induction coil 1307, so as to maximise heating efficiency.

A small bundle of quartz wool 1321b, on which light pyrolysis product was able to collect, was placed in the upper part of tube 1303 (heavy pyrolysis product was able to collected on the lower bundle of quartz wool 1321a). A gas collection pipe (not shown in FIG. 13) was also provided, comprising a short section of flexible tubing attached to the top of the quartz tube reactor to direct exhaust gases into a fume hood (also not shown in FIG. 13).

### Experimental Procedure

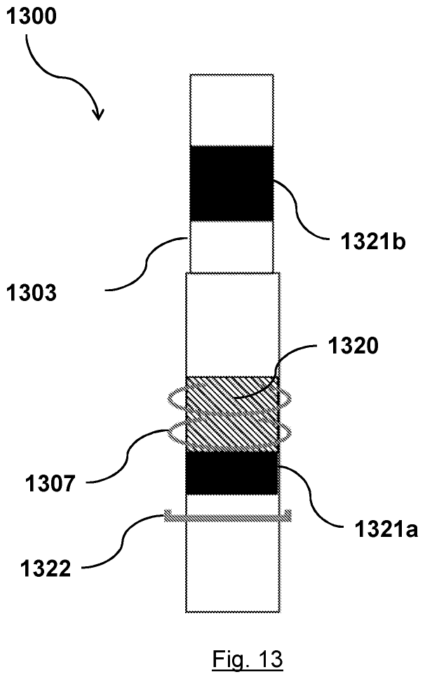

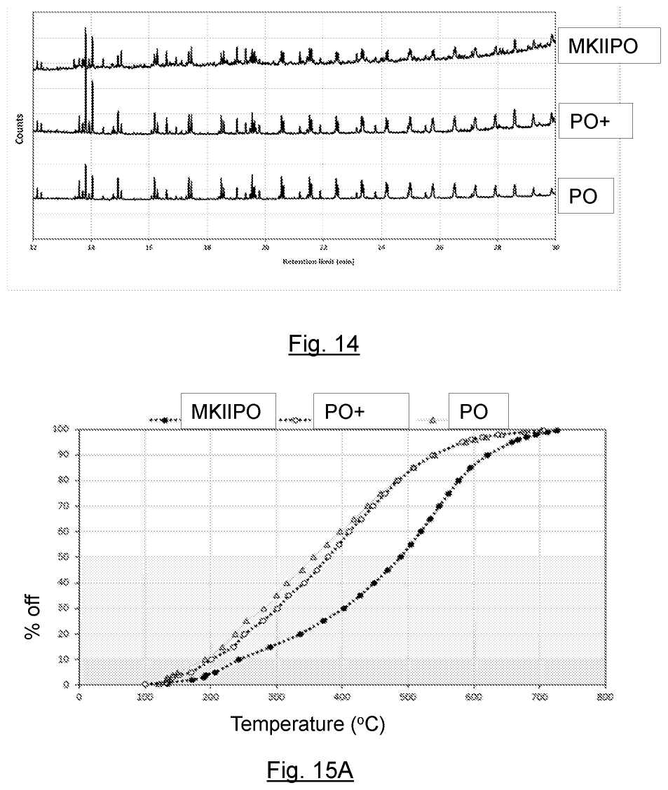

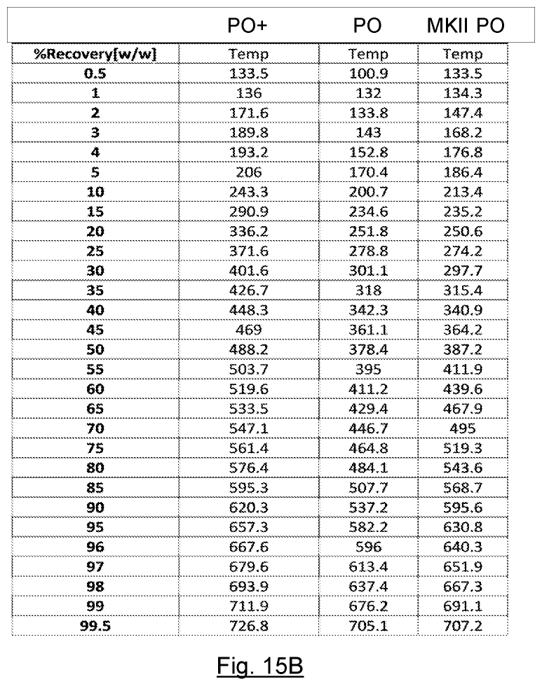

The induction system was operated at 150 A and 300 W to generate a temperature stable at approximately 500° C. In a first experiment (labelled PO+ in FIGS. 14 and 15), inert gas was supplied from the bottom of tube 1303. In a second experiment (labelled PO in FIGS. 14 and 15), no such inert gas was introduced. During each experiment run, the apparatus was operated for 15 minutes. Subsequently, the induction system was shut down and the apparatus left to cool. Between each experiment run, the apparatus was washed with acetone and replenished with fresh quartz wool 1321a, 1321b. Once cooled to room temperature, quartz wool 1321b, 1321a and any pyrolysis products deposited thereon were removed for analysis, using CS₂ as an extraction solvent. In each experiment run, the pyrolysis product collected from quartz wool 1321b, 1321a was combined to generate a single pyrolysis product sample for analysis.

The extracted pyrolysis product was analysed by GC-MS carried out using a Shimadzu GCMS-QP2020 NX (available from Shimadzu UK Ltd.). Samples were injected at approximately 0.1 mg/mL onto an SH-Rxi-5HT column (0.25 mm ID; 0.25 μm; 30 m; available from Restek Corp.) at an injection temperature of 300° C. An oven temperature ramp from 40 to 300° C. was undertaken over 30 minutes to elute compounds sequentially, in approximate molecular weight order. The total ion chromatogram from 5 minutes onwards is provided in FIG. 14 (avoiding solvent interference).

Simulated distillation analysis was performed in accordance with ASTM D2887 on the extracted pyrolysis product in CS₂. A Shimadzu GC-2030 machine (available from Shimadzu UK Ltd.) was used with on-column injection and liquid CO₂ oven cooling. The column used was MXT-1HT SimDist (0.53 mm ID; 0.10 μm; 5 m; available from Restek Corp.). The simulated distillation was calibrated against ASTM D2887 reference oil (C6-C44).

### GC-MS Analysis

FIG. 14 shows a comparison of the GC-MS results for the PO+ and PO experiments run, in comparison to the GC-MS results for a standard combustion heated pyrolysis reactor (MkIIPO). The standard combustion heater pyrolysis reactor, used as the reference in this example, is a fluidised bed pyrolysis reactor operated in a twin fluidised bed reactor system. An inert particulate material is heated by contact with hot gases in a fluidised bed combustion reactor, transferred to a fluidised bed pyrolysis reactor and contacted with the same polyolefin chip feedstock. As can be seen from FIG. 14, the product composition obtained in the first and second experiments is close to that of the standard combustion heated pyrolysis reactor, confirming a commercially acceptable product is formed.

### Simulated Distillation Analysis

FIG. 15A shows a comparison between the simulated distillation results for the PO+ and PO experiments run and the simulated distillation results for the standard combustion heated pyrolysis reactor (MkIIPO). As can be seen from FIG. 15A, the product composition obtained in the first and second experiments is close to that of the standard combustion heated pyrolysis reactor, again confirming a commercially acceptable product is formed. FIG. 15B shows a table of the data points of the graph of FIG. 15A.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A reactor system for pyrolysis of carbonaceous waste, comprising:
a fluidised bed pyrolysis reactor configured to pyrolyse carbonaceous waste to produce a pyrolysis product, wherein the reactor comprises a shell defining a heating chamber, the heating chamber having a fluidised bed zone configured to contain a fluidised bed of particulate material comprising particulate material susceptible to inductive heating; and
a pyrolysis induction heater assembly comprising an induction emitter configured to inductively heat said particulate material susceptible to inductive heating to a temperature of from 350° C. to 800° C. in the fluidised bed zone;
wherein the shell is made from an inductively inert material.

2. The reactor system of claim 1, wherein the induction emitter comprises at least one coil wrapped around the heating chamber.

3. The reactor system of claim 1, wherein the shell defining the heating chamber is an inner shell, and the pyrolysis reactor further comprises an outer shell separated from the inner shell by a thermally insulating material.

4. The reactor system of claim 1, wherein the fluidised bed pyrolysis reactor comprises a fluidising gas distributor positioned below the fluidised bed zone, the distributor being configured so as to allow a portion of the particulate material to fall through the distributor for removal from the reactor for cleaning and/or disposal via a particulate material outlet, and wherein the reactor comprises a particulate material inlet for feeding cleaned and/or fresh particulate material to the fluidised bed zone.

5. The reactor system of claim 1, further comprising cleaning apparatus for cleaning said particulate material, wherein the pyrolysis reactor and the cleaning apparatus are configured so that, in use, spent particulate material is transferred from the pyrolysis reactor to the cleaning apparatus for cleaning, and cleaned particulate material is transferred from the cleaning apparatus to the pyrolysis reactor.

6. The reactor system of claim 1, comprising particulate material for forming the fluidised bed in the pyrolysis reactor, the particulate material comprising said particulate material susceptible to inductive heating, wherein the particulate material susceptible to inductive heating comprises one or more electrically conductive and/or ferromagnetic materials.

7. The reactor system of claim 6, wherein the material susceptible to inductive heating comprises a ferromagnetic material having a Curie temperature of at least 450° C., such as at least 550° C.

8. The reactor system of claim 6, wherein the one or more electrically conductive and/or ferromagnetic materials is one or more of:
one or more electrically conductive and/or ferromagnetic elemental metals;
one or more electrically conductive and/or ferromagnetic metal alloys; and
one or more electrically conductive metal oxides.

9. The reactor system of claim 6, wherein the particulate material susceptible to inductive heating comprises one or more of elemental iron and/or magnetite.

10. The reactor system of claim 6, wherein the particulate material susceptible to inductive heating comprises ceramic particles at least partially coated with said one or more electrically conductive and/or ferromagnetic materials.

11. The reactor system of claim 6, wherein the particulate material susceptible to inductive heating comprises one or more molecular sieves comprising said one or more electrically conductive and/or ferromagnetic materials.

12. The reactor system of claim 6, wherein the particulate material further comprises particulate material not susceptible to inductive heating.

13. The reactor system of claim 12, wherein the percentage by weight of the particulate material not susceptible to inductive heating is greater than or equal to 10 wt %.

14. The reactor system of claim 12, wherein the percentage by weight of the particulate material susceptible to inductive heating is 40 wt % to 60 wt %, based on the total weight of particulate material.

15. The reactor system of claim 6, wherein the particulate material has a median particle diameter in a range of from 0.06 mm to 1 mm.

16. The reactor system of claim 1, wherein the carbonaceous waste comprises solid waste, such as biomass and/or plastic waste.

17. A method of treating waste comprising carbonaceous waste by pyrolysis in a reactor system according to claim 1 to form a pyrolysis product, wherein the method comprises:
fluidising particulate material comprising particulate material susceptible to inductive heating in the fluidised bed zone of the fluidised bed pyrolysis reactor;
operating the pyrolysis induction heater assembly to inductively heat the particulate material susceptible to inductive heating to a temperature in a range of from 350° C. to 800° C. in the fluidised bed zone; and
contacting the carbonaceous waste with the heated particulate material in the fluidised bed zone of the pyrolysis reactor, thereby pyrolysing the carbonaceous waste to form the pyrolysis product.

18. The method of claim 17, wherein the waste comprises plastic waste, such as mixed plastic waste or segregated plastic waste, such as polystyrene plastic waste.

19. The method of claim 17, wherein the method additionally comprises:
transferring particulate material to be cleaned from the fluidised bed pyrolysis reactor to cleaning apparatus for cleaning said particulate material, wherein the pyrolysis reactor and the cleaning apparatus are configured so that, in use, spent particulate material is transferred from the pyrolysis reactor to the cleaning apparatus for cleaning, and cleaned particulate material is transferred from the cleaning apparatus to the pyrolysis reactor;
cleaning the particulate material to be cleaned to form cleaned particulate material; and
returning the cleaned particulate material to the fluidised bed pyrolysis reactor.

20. The use of particulate material susceptible to inductive heating, wherein the particulate material susceptible to inductive heating comprises one or more electrically conductive and/or ferromagnetic materials, for forming a fluidised bed in a pyrolysis reactor in a reactor system according to claim 1.
